(19) United States
(12) Patent Application Publication
(10) Pub. No.: US 2009/0294453 A1
(43) Pub. Date: Dec. 3, 2009

(54) Stackable low permeation fuel tank

(76) Inventors: Christopher Brown, Merritt Island, FL (US); Marvin Peplow, Bartlett, IL (US)

Correspondence Address: CLIFFORD H. KRAFT, 320 ROBIN HILL DR., NAPERVILLE, IL, 60540, US

(21) Appl. No.: 12/313,671

(22) Filed: Nov. 21, 2008

Related U.S. Application Data
(63) Continuation-in-part of application No. 29/308,090, filed on May 27, 2008.

(51) Int. Cl. B65G 3/00

(52) U.S. Cl. 220/562

(57) ABSTRACT

A marine fuel tank that is stackable due to matching protrusions and recesses on the top and bottom and meets the new low hydrocarbon emission standard. In addition, the tank has side recesses that match straps and a handle that is designed to lift and pour. The tank is generally made from a polymer that has a hydrocarbon permeation of less than 15 g/sq. m/day.

This is a continuation-in-part of co-pending design patent application Ser. No. 29/308,090 filed May 27, 2008. This application is also related to co-pending application Ser. No. 11/986,554 filed Nov. 21, 2007. Applications Ser. Nos. 29/308,090 and 11/986,090 are hereby incorporated by reference.

### BACKGROUND

1. Field of the Invention

The present invention relates generally to marine fuel tanks and more particularly to a stackable fuel tank with extremely low hydrocarbon permeation.

2. Description of the Prior Art

New federal government regulations substantially tighten the amount of fuel a marine fuel tank such as those used with outboard motors can emit into the atmosphere each day. U.S. Government rules for marine fuel system hydrocarbon emissions are now 0.4 g/gallon/day for diumal venting from a fuel tank at 35.6 degrees C.; 1.5 g/gallon/day permeation from a fuel tank at 40 degrees C.; and 151 g/sq. meter/day for hose and primer bulb permeation at 23 degrees C. (15 g/sq. meter/day with 15% methanol blend fuel). A test fuel of 10% ethonol and 90% indolene can be used for normal testing. Prior art fuel tanks emit considerably more hydrocarbons into the atmosphere than this.

It would be advantageous to have a fuel tank made from regular or treated polymer material that can be stacked with other similar tanks for packaging and shipping and that has some sort of recess for straps.

### SUMMARY OF THE INVENTION

The present invention relates to a marine fuel tank that is stackable due to matching protrusions and recesses on the top and bottom and meets the new low hydrocarbon emission standard. In addition, the tank of the present invention has side recesses that match straps and a handle that is designed to lift and pour. The tank is generally made from a polymer material that has a hydrocarbon permeation of less than 15 g/sq. m/day.

### DESCRIPTION OF THE FIGURES

Attention is directed to several depictions to aid in understanding the present invention:

FIG. 1A shows a top view of an embodiment of the present invention.

FIG. 1B shows a side view of the embodiment of FIG. 1A

FIG. 2 shows a pair of tanks ready to stack.

FIG. 3 shows a bottom view of the embodiment of FIG. 1A.

Several illustrations and drawings have been presented to aid in understanding the present invention. The scope of the present invention is not limited to what is shown in the figures.

### DESCRIPTION OF THE INVENTION

The present invention relates to a fuel tank for a marine system such as an outboard motor. It is also applicable anywhere a small fuel tank is needed. Due the materials they are made from and the way they are made, most current fuel tanks cannot meet the new, stricter government standards for hydrocarbon emissions.

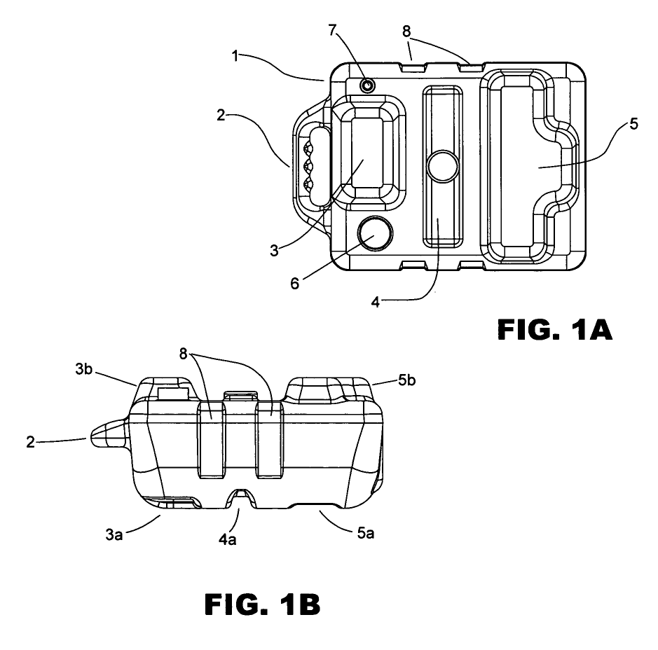

FIG. 1A-1B show a top and side view of an embodiment of the present invention. A tank 1 has a special handle 2 crafted and positioned with respect to a filler tube 6 so that a user can lift the tank and easily pour out fuel. In normal use, the filler tube or orifice 6 is fitted with a low emission sealed cap. A fuel line can connect to a primer and marine engine from an exit port 7.

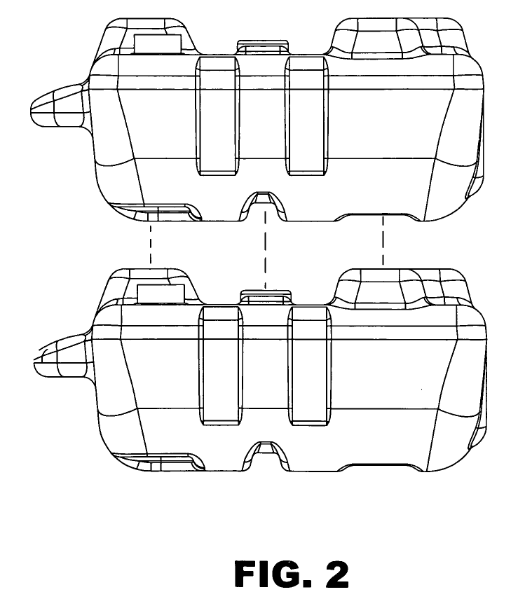

Protrusions on the top of the tank, and recessions on the bottom allow for easy stacking of multiple tanks for shipping and storage. A rear recess 5 (of any shape) on the top of one tank can match a rear protrusion 5a on the bottom of another tank. A front top recess 3 can match a bottom protrusion 3a, and a center protrusion 4 can match a bottom recess 4a. FIG. 2 shows two tanks of the present invention about to be stacked. It should be noted that while certain shaped and located recesses and protrusions have been shown for example, any shape or location of matching recesses and protrusions are within the scope of the present invention. In particular, the protrusions/recessions can be rectangular or round in a simple case.

Returning to FIGS. 1A-1B, side groves or recesses 8 can be seen that allow straps to be place around the tank. The recesses 8 prevent fore and aft slipping of a strap and provide a positive tie-down.

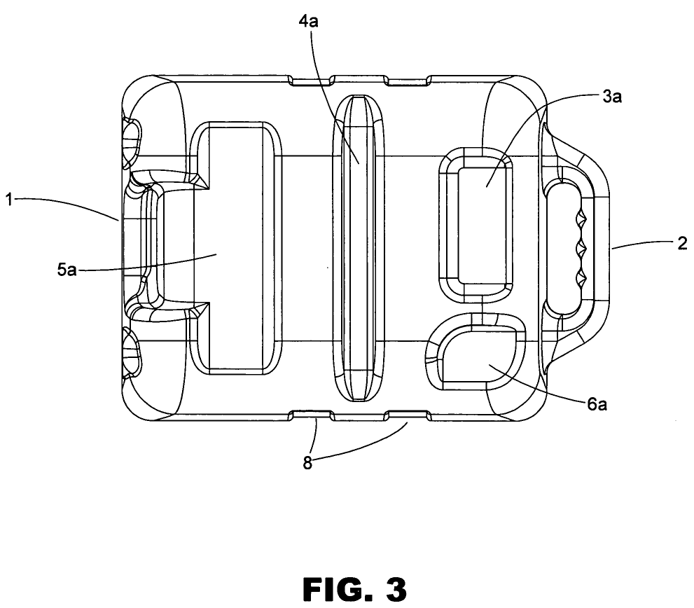

FIG. 3 shows a bottom view of the embodiment of FIGS. 1A-1B. The bottom protrusions 5a and 3a can be clearly seen as well as the bottom recess 4a. Also an additional recess 6a can be seen that matches the filler tube 6.

The preferred material for the tank is any rigid polymer that can meet the new low permeation standards of 15 g/sq. m/day. Among the materials that can be used is high density polyethylene, polybutylene terephthalate (PBT), polycarbonate, polycarbonate PBT (PC/PBT) Nylon 6, acetal(acetyl) and any other rigid or semi-rigid low permeation material. In particular polymers with embedded carbon fibers, carbon nano-tubes or clay materials such as smectite clay. The preferred carbon nano-fibers can have diameters from 50-70 nano-meters and have lengths up to several hundred microns.

The tank of the present invention can also be fabricated using a high-density closed cell urethane glass fiber reinforced composite sheet as a primary building block. Incorporating around 5% nanomer or nano sized treated clay particles/platelets into structural urethane adhesive provides a tank with a fuel resistant fastening medium. Introducing around 5% nanomer into a poly vinyl ester resin matrix retards the migration of hydrocarbons through the fuel tank walls and provides the tank interior and exterior coating. This is described in co-pending application Ser. No. 11/986,554. Any rigid or semi-rigid low permeation polymer or other material is within the scope of the present invention.

Several descriptions and illustrations have been presented to aid in better understanding the present invention. One skilled in the art will realize that numerous changes and variations are possible without departing from the spirit of the invention. Each of these changes and variations is within the scope of the present invention.

We claim:

1. A fuel tank for a small marine engine comprising, in combination:
a tank body with a filler orifice and a fuel hose connection, said tank body being fabricated from a material with hydrocarbon permeation less than 15 g/sq. meter/day;
said tank body having a plurality of matching protrusions and recesses on its top and bottom to facilitate stacking;
said tank body having at least one side strap recess on at least one side.

2. The fuel tank of claim 1 further comprising a handle on a first end located vertically near said top of said body and horizontally offset away from said filler orifice.

3. The fuel tank of claim 1 wherein said material is a polyethylene.

4. The fuel tank of claim 1 wherein said material is a polymer containing carbon fibers.

5. The fuel tank of claim 1 wherein said material is a polymer containing smectite clay.

6. The fuel tank of claim further comprising a plurality of strap recesses on each of two sides of said tank body.

7. A fuel tank for a small marine engine comprising, in combination:
a tank body with a filler orifice and a fuel hose connection, said tank body being fabricated from a material with hydrocarbon permeation less than 15 g/sq. meter/day;
said tank body having a plurality of matching protrusions and recesses on its top and bottom to facilitate stacking;
said tank body having at least one side strap recess on at least one side;
a handle on a first end located vertically near said top of said body and horizontally offset away from said filler orifice.

8. The fuel tank of claim 7 wherein said material is a polyethylene.

9. The fuel tank of claim 7 wherein said material is a polymer containing carbon fibers.

10. The fuel tank of claim 7 wherein said material is a polymer containing smectite clay.
